(19) United States
(12) Patent Application Publication
(10) Pub. No.: US 2004/0252998 A1
(43) Pub. Date: Dec. 16, 2004

(54) Infrared (ir) transmission device

(76) Inventors: Andreas Schalk, Graz (AT); Raimund Pammer, Graz (AT); Helmut Rieder, Graz (AT)

Correspondence Address: WILLIAM COLLARD, COLLARD & ROE, P.C., 1077 NORTHERN BOULEVARD, ROSLYN, NY, 11576, US

(21) Appl. No.: 10/495,986

(22) PCT Filed: Nov. 19, 2002
(86) PCT No.: PCT/AT02/00322

(30) Foreign Application Priority Data
Nov. 20, 2001 (AT) A 1826/2001

(51) Int. Cl. H01S 3/00

(52) U.S. Cl. 398/135

(57) ABSTRACT

An infrared (IR) transmission device comprising IR transmitter and receiver elements arranged in a housing, wherein a common, multi-segment lens element (29, 29A, 29B) is arranged ahead of the IR elements (22, 32), and each IR element (22, 32) has an associated lens segment (32, 33) of the lens element (29, 29A, 29B).

The invention relates to an infrared (IR) transmission device comprising IR transmitter and receiver elements arranged in a housing.

Infrared transmission devices are quite generally known, e.g. in remote controls for electronic devices for consumers, such as television sets, VCR and stereo equipment, but also for electronic toll systems. As a rule, however, communication by means of infrared signals is possible merely over short distances, such as in the range of DSRC communication (dedicated short range communication), usually covering a range of less than 10 m. In not previously published application AT 77/2001 of Applicant, a selective wireless communication device has been suggested with which ranges of up to 100 or 200 m are possible, and there requests at so-called OBUs (on board units) arising in connection with the checking of the orderly payment of tolls, parking fees or the like are concerned.

In the field of telecommunication, the connection or “lacing” of individual subscribers to the telecommunication network of a network provider is one of the main problems. This connection of the subscribers to the network usually is called “subscriber line” or “last mile”, respectively. This subscriber line is not so much a problem for established network providers, since they already have sufficient subscriber cable networks from the past, yet for new network providers they constitute a problem since they either have to rent existing lines from established network providers or have to install lines themselves, which is work and cost intensive; therefore, in this connection the use of alternative technologies is desired, such as on the basis of DECT systems or GSM systems which, however, have the drawback of small band widths and expensive frequency licenses; another, also very expensive alternative associated with expensive frequency licenses are digital radio links, optionally also optic laser connections.

It is now an object of the invention to provide an infrared transmission device of the initially defined type which enables a signal transmission over extended distances, depending on the respective embodiment over several hundred meters to more than 1000 m, and which thus is suitable to be used in optic “last mile” solutions, which is cost efficient therefore also widely applicable, and which offers sufficiently large transmission band widths as well as a data transmission with an active error correction.

To solve this problem, the present invention provides an infrared transmission device with infrared transmitter and receiver elements arranged in a housing, wherein a common, multi-segment lens element is arranged ahead of the infrared elements and each infrared element has an associated lens segment of the common lens element.

Thus, the invention provides for a widely applicable, extremely cost-efficient infrared solution particularly for the “last mile” signal transmission, wherein, due to to indicated lens element in combination with the IR transmitter and receiver elements arranged therebehind, particularly provided in larger numbers, transmission is also possible over larger distances, up to 1000 m and more, rendering it suitable for subscriber connections. By the infrared transmission technique a transmission rate of from 10 to more than 100 Mbit/s is possible, i.e. approximately the more than 10-fold transmission rate when compared with ADSL systems, or the more than 100-fold capacity when compared with the ISDN systems. Furthermore, a data connection to the networks usually used by network providers, such as, e.g., ATM, SONET or also LAN networks, e.g. Ethernet, is possible without any problems. The infrared transmission technique also allows for active error correction and redundancy methods as necessarily required for servicing sensitive subscriber sites; furthermore, a remote administration of the transmission device is possible (via a so-called Q-interface). The transmission device with the common, multi-segment lens element can be produced, mounted and oriented in a simple and cost-efficient manner; in particular, the multi-segment lens element may also be made of plastics in a technology known per se, e.g. from the production of CD discs, e.g. as an injection-molded part, a pressed part or a part formed by embossing, wherein, moreover, also in the lens element, at least in regions thereof, an optic filter effect may already be provided by the incorporation of dyestuffs.

In comparison with conventional RF technologies for the last mile application, it is a further advantage that a permit for carrier frequencies is not required, that higher band widths and a more efficient transmitting power can be attained, furthermore, that the communication zones are well adaptable to the respective application, and that minimum distances to the next communication device are conceivable. Furthermore, intermodulation phenomena as a consequence of neighboring carrier frequencies are avoided, and a particular advantage is also the avoidance of electromagnetic pollution. Infrared as such is contained in sunlight and does not pose any risk for humans and animals. Furthermore, the infrared transceiver technology which, as such, is known per se, is a cost-efficient technology. Here it is particularly suitable if incoherent infrared radiation is used out of doors as a high-capacity, bi-directional data transmission medium. In this manner, also in comparison with any possible solutions using infrared laser, a substantially more cost-efficient realization with reduced expenditures also during mounting and orienting is achieved. Furthermore, due to the incoherent transmission medium, a high reliability during signal-transmission is ensured.

The multi-segment lens element may, e.g., be made of acrylic glass or of polycarbonate, any of the previously mentioned, per se known production techniques being suitable for the production thereof. The lens element may be produced in one piece, yet for many applications it is also suitable if the multi-segment lens element is assembled with a transparent carrying plate made, e.g. of glass. With a view to a simple design, it is furthermore advantageous if the multi-segment lens element, optionally in combination with the carrying plate, forms a cover for the housing.

The lens segments may be refractive optic elements in which a beam deflection thus occurs due to a refraction on the interfaces, with the injection-molding technique being a particularly suitable production method therefor. On the other hand, a design with diffractive elements in master replica technique, injection-molding technique or embossing technique is advantageous, wherein in these diffractive lens segments, which comprise Fresnel lenses, the beam deflection occurs by diffraction. Defined grating structures are provided for the desired imaging properties, and gratings on the plane side of the lens segments are capable of compensating for the spheric aberration; diffractive beam mutliplexers can divide an incident infrared beam into a set of equal beams, or they can produce arbitrary intensity distributions from a Gaussian profile.

As has been mentioned, by incorporating laser dye colorants or the like, optic filter effects may simultaneously be provided in the lens element so as to provide a daylight barrier. As the transmitter and receiver element, respectively, per se known, commercially available infrared LED transmitting diodes with integral optics (lens) and a mounting suitable for production in quantities may be used, and per se conventional PIN diodes with integral receiving filter may be employed as the receiver elements, respectively.

To attain a high transmission power, it has also proved advantageous if the multi-segment lens element is designed with a central receiver element-lens segment and a number of transmitter element-lens segments located externally thereof. To efficiently use the available space, it is furthermore suitable if the transmitter element-lens segments are arranged according to a circle line around the central receiver element-lens segment. Furthermore, for an adequate sensitivity when receiving infrared radiation, it is advantageous if, seen in top view, the receiver element-lens segment is larger than any individual transmitter element-lens segment.

With a view to a simple manufacture and mounting, respectively, the IR transmitter and receiver elements may be integrated on a single, common circuit board which may form a type of intermediate bottom in the housing.

It should be mentioned that from U.S. Pat. No. 5,187,360 A as such a multi-range lens comprising a number of lens regions is already known, yet this multi-range lens is formed with the lens segments being three-dimensionally arranged such that the individual lens regions receive their radiation from a certain zone, without being able to receive radiation from neighboring zones, wherein the individual lens regions are to focus the radiation originating from various zones to a common focal point. Such a multi-range lens obviously would not be suitable for the above addressed application in the field of telecommunication, and directional transmitting and receiving, respectively, would not be possible, much rather numerous interference signals would superimpose the useful signal transmission.

In the following, the invention will be explained in more detail by way of preferred exemplary embodiments illustrated in the drawing to which, however, it shall not be restricted. In detail,

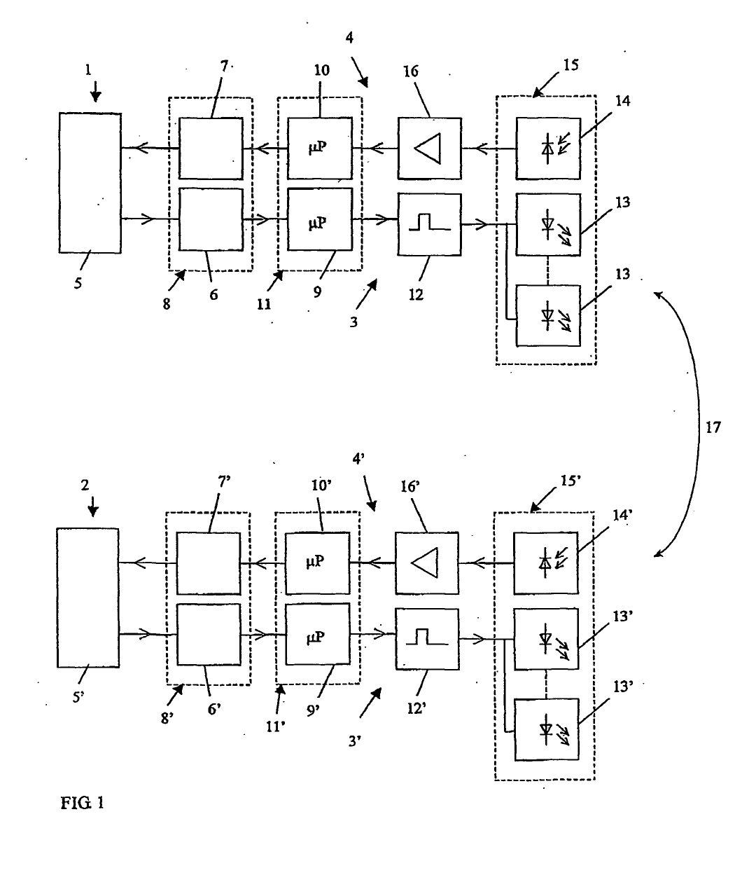

FIG. 1 shows a schematic block diagram of an IR transmission device to be connected to a subscriber in a telecommunication network;

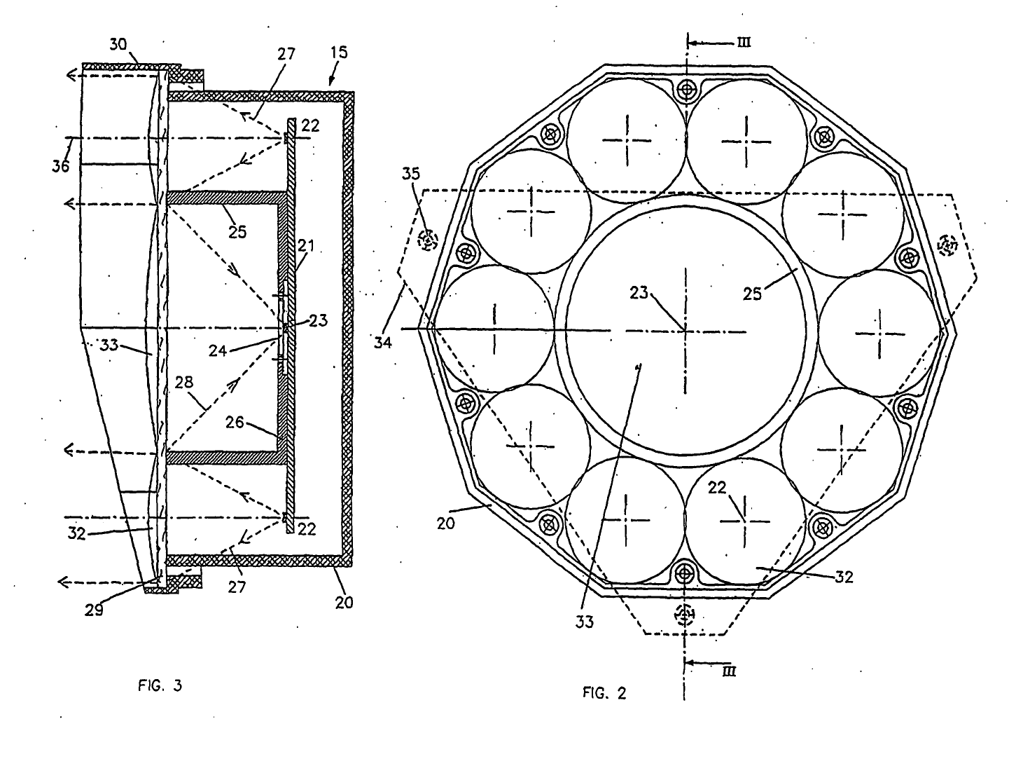

FIG. 2 shows a top view onto an embodiment of an IR transmission device illustrating the common, multi-segment lens element;

FIG. 3 shows a cross-section through this transmission device according to line III-III of FIG. 2;

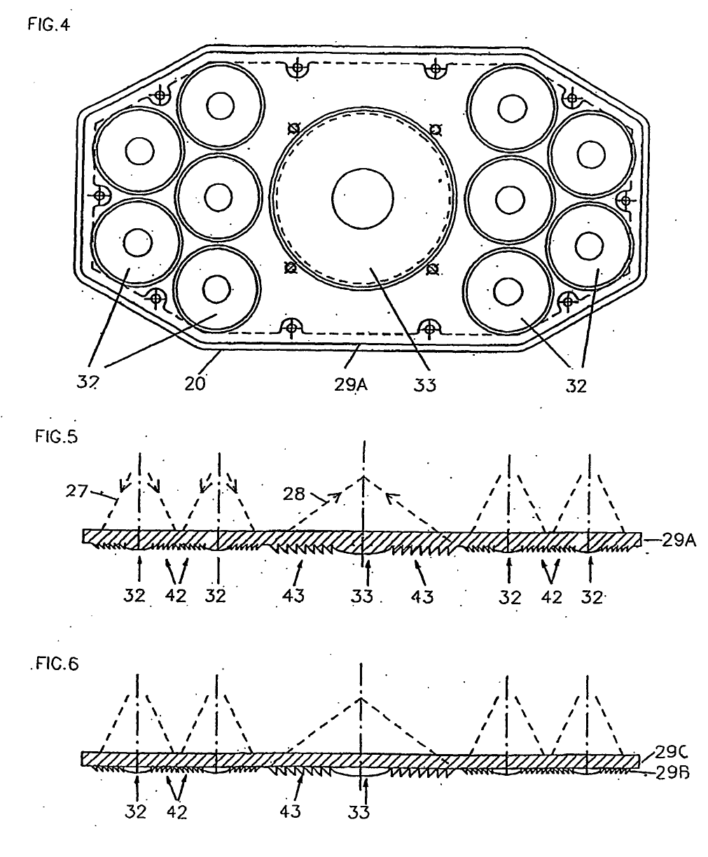

FIG. 4 shows another embodiment of the inventive IR transmission device in a top view similar to FIG. 2;

FIGS. 5 and 6 show two different embodiments for the common, multi-segment lens segment in schematic sectional representations, i.e. as a single-piece part (FIG. 5), on the one hand, and designed in two pieces with a carrier plate of glass and a lens element proper attached thereto, on the other hand; and

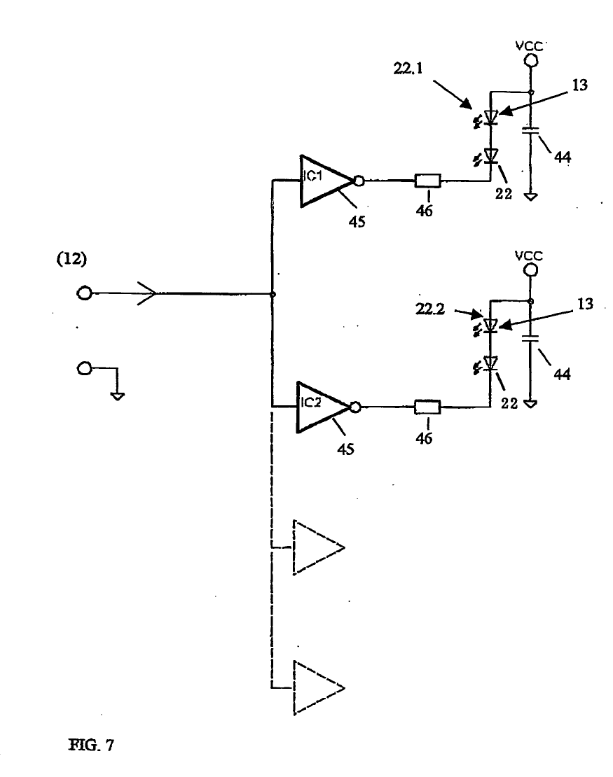

FIG. 7 shows an example of a transmission diode driver circuit.

In FIG. 1, an IR transmission device for connecting a subscriber 1 to a network 2 is schematically illustrated in a block diagram. On the side of subscriber 1, the transmission device comprises a transmitting part 3 and a receiving part 4, a conventional telecommunication appliance, e.g. a telephone etc., denoted by 5 in FIG. 1, being connected to a transmitter microprocessor 9 and to a receiver microprocessor 10, respectively, of a microprocessor unit 11 via a transmitter interface 6 and a receiver interface 7, respectively, of an interface unit 8. The transmitting part 3 is then followed by a pulse former 12 which drives IR transmitter elements 13 (only two transmitter elements 13 are shown in FIG. 1 for the sake of simplicity). These IR transmitter elements 13 are combined with at least one IR receiver element 14 in a common assembly 15, as will become more clearly apparent from the description of FIGS. 2 and 3, and to the IR receiver element 14, an amplifier 16 is connected as an electronic component having an output which in turn is connected to the receiver microprocessor 10.

Corresponding components are provided on the side of the network 2, a repetition of the description not being required; in FIG. 1, the corresponding elements on the network side are designated by the same reference numerals as on the subscriber side, yet they are provided with an apostrophe. The network proper follows at 5′. The communication between the two devices is effected by means of infrared radiation 17 (cf. the double arrow in FIG. 1).

In FIGS. 2 and 3, an embodiment of the transmitter and receiver assembly 15 is shown, wherein, e.g., a generally can-shaped housing 20, which is decagonal seen in top-view, is provided in the interior of which a common circuit board 21 with e.g. 10 IR tansmitter diodes 22 and with a central IR receiver diode 23 is mounted. The receiver diode 23 is located in the region of an opening 24 of an inner cylindrical shield 25, said opening 24 being provided in the bottom 26 of this shield 25. By this, the receiving region of the assembly 15 is separated from the transmitting region, the transmitting region being formed by a generally annular space extending around the cylindrical shield 25. In FIG. 3, the angle of radiation of the transmitter diodes 22 is schematically indicated by broken lines at 27 and the receiving or input region of the receiver element 23 at 28.

A common multi-segment, substantially plate-shaped lens element 29 serves as housing cover for the housing 20, the lens element 29 being arranged within a shielding screen 30 to shield it from undesired ambient radiation and being provided with individual lens segments 32, 33 for the receiver and transmitter elements. Accordingly, in detail, transmitter lens elements 32 which are substantially circular seen in top view (cf. FIG. 2) and which are arranged ahead of the IR transmitter diodes 22, and a central receiver lens segment 33 are integrated in the lens element 29. The lens elements 32, 33 may be formed by outwardly convex areas of the lens element 29, as is schematically indicated in FIG. 3, preferably in combination with grating structures or Fresnel lens structures, as results from FIGS. 5 and 6 which will be further explained hereinafter.

From FIG. 3, it can furthermore be seen that the shielding screen 30 preferably is formed in one part with the housing 20. Furthermore, FIG. 2 shows in broken lines 34 a mounting plate which is attached to the bottom side or rear side of housing 20 and serves to fasten the optic assembly 15 on a carrier not further illustrated, e.g. by means of screws screwed through screw holes (not illustrated).

From FIG. 3 it is furthermore visible that the IR beam 27 which is radiated from the transmitter elements 22 at first has an angle of aperture of 2×20° to 25°, i.e. in sum 40° to 50°, this still being so within housing 20. By the respective associated, e.g. plane-convex lens segment 32, this beam 27 then will be collimated to a more or less parallel beam—at the exit side of the respective lens segment 32, this beam possibly diverging corresponding to half an angle of aperture of 1° or of a few degrees. By this “parallel orientation” of the beams 27, in sum there results a strong focussing of all the IR beams of the transmitter elements 22, whereby a circular-ring-shaped total beam bundle is obtained which impinges on the receiver lens segment 33 of the counter-site (i.e., at 14′, e.g.,) at a distance of a few hundred meters and by this lens segment 33 is focused on the opening 24 present there and on the receiver element 23. Optionally, the individual IR beams 27 may all be focused with their axes 36 all slightly converging to each other, and to this end, the lens segments 32 are provided to extend appropriately curved to thus allow for as much IR light to impinge on the receiver lens segment of the counter-site as possible.

Of course, besides the arrangement of the lens segments 32, 33 shown in FIG. 2, with the transmitter lens segments 32 arranged according to a circular line about a central receiver lens element 33, also other arrangements of the lens segments 32, 33 on the lens element 29 are possible. Thus, for instance, an arrangement of the outer transmitter lens segments according to a square or a rectangle about a central receiver lens element—which again may be larger than the transmitter lens elements—is conceivable.

In FIG. 4, an embodiment is shown in which, in a lens element 29A, two groups of transmitter lens segments 32—and, accordingly, two groups of IR transmitter diodes arranged therebehind and not shown in FIG. 4—are provided on either side of a central receiver lens element 33 which, again, is larger—a receiver diode again being provided therebehind. The lens element 29A according to FIG. 4 thus has an octagonal shape, with a large rectangular middle portion and two laterally added trapezoidal portions, and again it may be formed in one piece of transparent plastics, such as acrylic glass or polycarbonate.

FIG. 5 shows such a single-part lens element 29A, wherein here it is additionally schematically indicated that each individual lens segment 32, or 33, respectively, on its outer side or front side is provided with a Fresnel lens structure 42, or 43, respectively, so as to achieve the desired bundling, or focussing, respectively, of the beams 27 or 28, respectively (FIG. 3). This structure of the lens element 29A (and also of the lens element 29 according to FIGS. 2, 3, and of the lens element 29B according to FIG. 6 described hereinafter) can be obtained by embossing, but also by injection molding, the Fresnel lens structures 42, 43—which, compared to information tracks on CD information carriers are still rough structures—can be co-formed without any problems, whereby a simple production, in particular a mass production, is rendered possible. As the material for the lens elements 29 (and 29A and 29B, respectively), also epoxide resin may be used, besides acrylic glass or polycarbonate, respectively, and a dyestuff for filtering out undesired frequences may be incorporated into the material.

According to FIG. 6, the filter element 29B proper is mounted on a carrying plate 29C which may be made of glass or of acrylic glass.

Of course, also more than 10, e.g. 12 or 16 etc., IR transmitter diodes 22 may be provided in the assembly 15; it is also possible to mount an array of receiver diodes connected together, in particular connected in parallel, on the circuit board 21 (FIG. 3) instead of one IR receiver diode 23.

In FIG. 7, an example of a driver circuit for the transmitter elements 13, i.e. IR transmitter diodes 22, is illustrated, it being visible that several transmitter diodes 22 are connected in series in a group 22.1, 22.2, and several transmitter diode groups 22.1., 22.2 may be connected in parallel. Each group 22.1, 22.2 is connected to a supply voltage VCC, a capacitor 44 being connected in parallel for energy buffering purposes. The signal coming from the pulse former 12 (FIG. 1) and to be transmitted is supplied in electric form to each transmitter diode group 22.1, 22.2 via a driver gate 45 with inverting output and a series resistor 46.

Instead of the driver circuit shown, of course also other activating means known per se may be used for the transmitter diodes.

Correspondingly, the receiver diodes 23 may be connected to a voltage supply in a conventional manner and connected to the respective amplifier (16 in FIG. 1) via a band-pass filter (not illustrated).

1. An infrared (IR) transmission device comprising IR transmitter and receiver elements arranged in a housing, wherein a common, multi-segment lens element (29, 29A, 29B) is arranged ahead of the IR elements (22, 32), wherein each IR element (22, 32) has an own associated lens segment (32, 33) of the lens element (29, 29A, 29B).

2. A transmission device according to claim 1, wherein an injection-molded part is provided as said multi-segment lens element (29, 29A, 29B).

3. A transmission device according to claim 1, wherein a pressed part is provided as said multi-segment lens element (29, 29A, 29B).

4. A transmission device according to claim 1, wherein an embossed part is provided as said multi-segment lens element (29, 29A, 29B).

5. A transmission device according to claim 1, wherein the multi-segment lens element (29, 29A, 29B) is designed as an optic filter at least in regions thereof.

6. A transmission device according to claim 5, wherein the optic filter is formed by incorporating a colorant in the multi-segment lens element (29, 29A, 29B).

7. A transmission device according to claim 1, wherein the multi-segment lens element (29, 29A, 29B) is made of acrylic glass.

8. A transmission device according to claim 1, wherein the multi-segment lens element (29, 29A, 29B) is made of polycarbonate.

9. A transmission device according to claim 1, wherein the multi-segment lens element (29, 29A) is made in one piece.

10. A transmission device according to claim 1, wherein the multi-segment lens element (29B) is assembled with a transparent carrying plate (29C).

11. A transmission device according to claim 10, wherein the transparent carrying plate (29C) is made of glass.

12. A transmission device according to claim 1, wherein the multi-segment lens element (29, 29A, 29B), optionally in combination with the carrying plate (29C), forms a cover for the housing (20).

13. A transmission device according to claim 1, wherein at least one lens segment (32, 33) is designed as a refractive region.

14. A transmission device according to claim 1, wherein at least one lens segment (32, 33) is designed as a diffractive region.

15. A transmission device according to claim 1, wherein at least one lens segment (32, 33) is designed as a Fresnel lens.

16. A transmission device according to claim 1, wherein the multi-segment lens element (29, 29A, 29B) is designed with a central receiver element-lens segment (33) and a number of transmitter element-lens segments (32) located externally thereof.

17. A transmission device according to claim 16, wherein the transmitter element-lens segments (32) are arranged according to a circle line around the central receiver element-lens segment (33).

18. A transmission device according to claim 16, wherein, seen in top view, the receiver element-lens segment (33) is larger than any individual transmitter element-lens segment (32).

19. A transmission device according to claim 1, wherein the IR transmitter and receiver elements (22, 23) are designed for an incoherent IR radiation.

20. A transmission device according to claim 1, wherein the IR transmitter and receiver elements (22, 23) are integrated on a single circuit board (21).

21. A transmission device according to claim 1, wherein the IR transmitter elements (22) are formed by IR-LED transmitter diodes with integral optics.

22. A transmission device according to claim 1, wherein the IR receiver elements (23) are formed by PIN-diodes.
